(19) United States
(12) Patent Application Publication
(10) Pub. No.: US 2010/0327153 A1
(43) Pub. Date: Dec. 30, 2010

(54) USE OF SOLID CRYSTALS AS CONTINUOUS LIGHT PIPES TO FUNNEL LIGHT INTO PMT WINDOW

(75) Inventor: Eric Molz, Houston, TX (US)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/825,468

(22) Filed: Jun. 29, 2010

Related U.S. Application Data
(60) Provisional application No. 61/221,249, filed on Jun. 29, 2009.

(51) Int. Cl. G01V 5/04; G01T 1/202

(52) U.S. Cl. 250/256

(57) ABSTRACT

An apparatus for estimating a property in a borehole penetrating the earth, the apparatus having: a carrier configured for being conveyed through the borehole; a scintillation crystal disposed at the carrier, a first portion of the crystal having a first cross-sectional area; and a photodetector optically coupled to the scintillation crystal and configured to detect photons generated in the crystal by interactions with radiation to estimate the property, the photodetector having a second cross-sectional area configured to couple to the crystal; wherein the crystal at a second portion tapers from the first cross-sectional area to the second cross-sectional area to guide the generated photons to the photodetector.

### CROSS-REFERENCE TO RELATED APPLICATIONS AND PRIORITY CLAIM

This application claims the benefit of U.S. Provisional Application Ser. No. 61/221,249, entitled “THE USE OF SOLID CRYSTALS AS CONTINUOUS LIGHT PIPES TO FUNNEL LIGHT INTO PMT WINDOW”, filed Jun. 29, 2009, under 35 U.S.C. §119(e), which is incorporated herein by reference in its entirety.

### BACKGROUND OF THE INVENTION

1. Field of the Invention

The invention disclosed herein relates to scintillating crystals and, in particular, to using the crystals to measure radiation in a borehole penetrating the earth.

2. Description of the Related Art

Exploration and production of hydrocarbons require precise and accurate measurements of earth formations, which may contain reservoirs of the hydrocarbons. The reservoirs are accessed by drilling boreholes into the earth formations. Well logging is one technique used to perform the measurements from within the boreholes.

In one type of well logging referred to as logging-while-drilling (LWD), a logging tool is disposed at a drill string used to drill a borehole. As the drill string rotates to drill the borehole, the logging tool can perform measurements. The logging tool includes those components such as sensors and processors used to perform the measurements. As the logging tool is conveyed through the borehole by the drill string, the measurements are performed at various depths. The measurements are associated with the depths at which they were performed and displayed as a log.

Various types of measurements can be made to produce a log. One type of measurement involves measuring radiation. The radiation can include gamma rays or neutrons. Radiation levels and energies received can be used to measure formation properties such as density, porosity and composition for example.

One way of measuring radiation is to use a scintillation crystal optically coupled to a photomultiplier tube (PMT). The scintillation crystal interacts with the radiation to produce photons, which are detected and measured by the PMT.

In order to make accurate and precise measurements of the radiation, it is desirable to use as large a scintillation crystal as possible. The large scintillation crystal will collect and detect more radiation than a smaller scintillation crystal and, thus, improve the counting statistics associated with measuring the radiation.

Unfortunately, conventional PMTs for LWD come in standard sizes that are typically smaller than the large scintillation crystals desired. A mismatch between the scintillation crystal and the PMY, though, can cause multiple reflections of the photons. Many of these photons can be lost to dispersion and, thus, not detected by the PMT. Accordingly, loss of photons generated in the scintillation crystal can decrease the size of any one pulse or cause the loss of a pulse altogether, lower the counting statistics, and lower the accuracy and precision of the measurements of radiation.

Therefore, what are needed are techniques for improving the accuracy and precision of measuring radiation downhole.

### BRIEF SUMMARY OF THE INVENTION

Disclosed is an apparatus for estimating a property in a borehole penetrating the earth, the apparatus having: a carrier configured for being conveyed through the borehole; a scintillation crystal disposed at the carrier, a first portion of the crystal having a first cross-sectional area; and a photodetector optically coupled to the scintillation crystal and configured to detect photons generated in the crystal by interactions with radiation to estimate the property, the photodetector having a second cross-sectional area configured to couple to the crystal; wherein the crystal at a second portion tapers from the first cross-sectional area to the second cross-sectional area to guide the generated photons to the photodetector.

Also disclosed is a method for estimating a property in a borehole penetrating the earth, the method including: conveying a carrier through the borehole; receiving radiation with a scintillation crystal disposed at the carrier, a first portion of the crystal having a first cross-sectional area; generating photons from interactions of the radiation with the crystal; and detecting the photons with a photodetector optically coupled to the scintillation crystal to estimate the property, the photodetector having a second cross-sectional area configured to couple to the crystal; wherein the crystal at a second portion tapers from the first cross-sectional area to the second cross-sectional area to guide the generated photons to the photodetector.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a drill string that includes a logging tool;

FIG. 2 illustrates an exemplary embodiment for well logging with a logging tool deployed by wireline;

FIG. 3 depicts aspects of an embodiment of the logging tool that measures radiation;

FIG. 4 illustrates a three-dimensional view of a scintillation crystal;

FIG. 5 depicts aspects a hygroscopic scintillation crystal disposed in a container; and

FIG. 6 depicts one example of a method for estimating a property downhole.

### DETAILED DESCRIPTION OF THE INVENTION

Disclosed are embodiments of techniques for measuring radiation in a borehole penetrating the earth. The techniques call for using a radiation detector having a large scintillation crystal optically coupled to a photo-multiplier tube (PMT). In general, a cross-sectional area of the main detecting portion of the scintillation crystal is larger than the cross-sectional area of the PMT where the PMT optically interfaces with the scintillation crystal. The large scintillation crystal detects more radiation than would be detected with a smaller scintillation crystal. Thus, the large scintillation crystal improves the accuracy and the precision of the radiation measurements by producing a count rate of the radiation detector that is higher than the count rate would be with a normal sized scintillation crystal.

In order to optically couple the scintillation crystal to the PMT, the techniques call for machining or forming a transition portion of the scintillation crystal to form a section that tapers from the large cross-sectional area at the main detection portion of the scintillation crystal to the smaller cross-sectional area of the PMT. The transition portion guides photons generated by the interaction of the radiation in the crystal to the PMT. Without the transition portion, some the photons will undergo multiple reflections, dispersion, and absorption due to the mismatch in the cross-sectional areas and, therefore, not be detected or counted by the PMT. Thus, the benefit of using the larger scintillation crystal will be realized by having the transition portion to limit the number of photons that would be lost due to the different cross-sectional areas.

Before the techniques are discussed in detail, certain definitions are presented for convenience. The term “scintillation crystal” relates to a crystal material that generates photons upon the material interacting with radiation. Generally, the amount of photons generated is related to the amount of radiation interacting with the scintillation crystal. Non-limiting examples of the radiation include gamma rays and neutrons. Non-limiting embodiments of the scintillation crystal for detecting gamma rays include sodium iodide, bismuth germinate, and a lanthanum halide such as lanthanum bromide or lanthanum chloride for example. Non-limiting embodiments of the scintillation crystal for detecting neutrons include lithium-six and boron-ten. The term “photodetector” relates to a device that is optically coupled to the scintillation crystal and detects the photons generated within the crystal. The detection can include counting the number of photons entering the photodetector and energy levels associated with the photons. Non-limiting embodiments of the photodetector include the PMT, a photodiode, and a plurality of photodiodes.

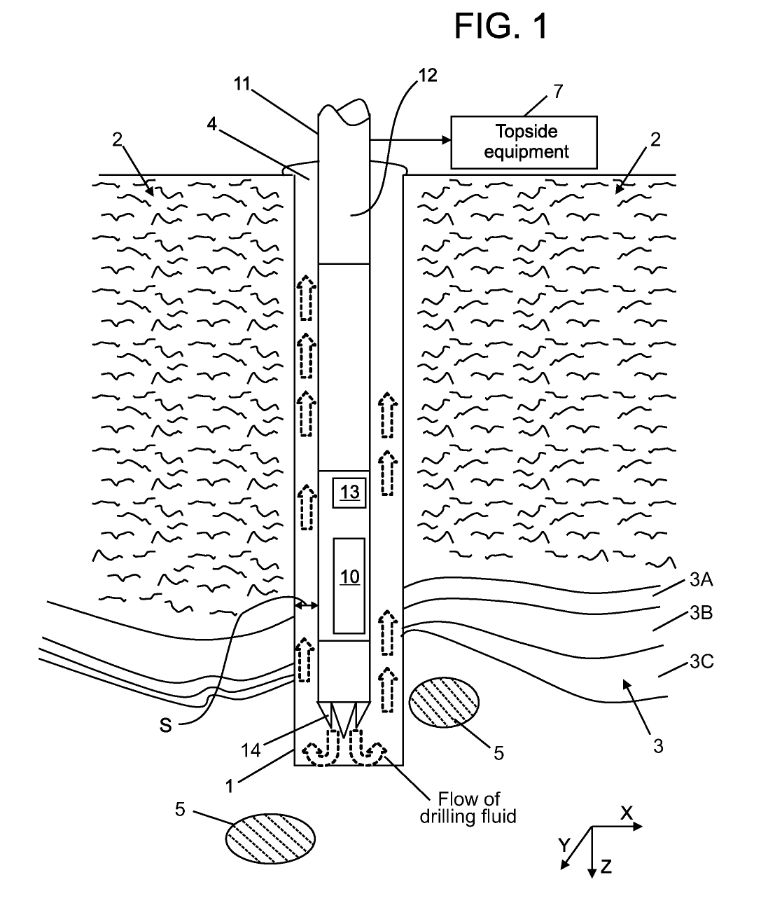

Reference may now be had to FIG. 1 where aspects of an apparatus for drilling a wellbore 1 (also referred to as a “borehole”) are shown. As a matter of convention, a depth of the wellbore 1 is described along a Z-axis, while a cross-section is provided on a plane described by an X-axis and a Y-axis.

In this example, the wellbore 1 is drilled into the Earth 2 using a drill string 11 driven by a drilling rig (not shown), which, among other things, provides rotational energy and downward force. The wellbore 1 generally traverses sub-surface materials, which may include various formations 3 (shown as layers of formations 3A, 3B, 3C). One skilled in the art will recognize that the various geologic features as may be encountered in a subsurface environment may be referred to as “formations,” and that the array of materials down the borehole (i.e., downhole) may be referred to as “sub-surface materials.” That is, the formations 3 are formed of sub-surface materials. Accordingly, as used herein, it should be considered that while the term “formation” generally refers to geologic formations, and “sub-surface material,” includes any materials, and may include materials such as fluids, gases, liquids, and the like.

The drill string 11 includes lengths of drill pipe 12 which drive a drill bit 14. In this example, the drill bit 14 also provides a flow of a drilling fluid 4, such as drilling mud. The drilling fluid 4 is often pumped to the drill bit 14 through the drill pipe 12, where the fluid exits into the wellbore 1. This results in an upward flow of drilling fluid 4 within the wellbore 1. The upward flow generally cools the drill string 11 and components thereof, carries away cuttings from the drill bit 14 and prevents blowout of pressurized hydrocarbons 5.

The drilling fluid 4 (also referred to as “drilling mud”) generally includes a mixture of liquids such as water, drilling fluid, mud, oil, gases, and formation fluids as may be indigenous to the surroundings. Although drilling fluid 4 may be introduced for drilling operations, use or the presence of the drilling fluid 4 is neither required for nor necessarily excluded from well logging operations. Generally, a layer of materials will exist between an outer surface of the drill string 11 and a wall of the wellbore 1. This layer is referred to as a “standoff layer,” and includes a thickness, referred to as “standoff, S.”

The drill string 11 generally includes equipment for performing “measuring while drilling” (MWD), also referred to as “logging while drilling” (LWD). Performing MWD or LWD generally calls for operation of a logging instrument 10 that is incorporated into the drill string 11 and designed for operation while drilling. Generally, the MWD logging instrument 10 is coupled to an electronics package, which is also on board the drill string 11, and therefore referred to as “downhole electronics 13.” Generally, the downhole electronics 13 provides for at least one of operational control and data analysis. Often, the MWD logging instrument 10 and the downhole electronics 13 are coupled to topside equipment 7. The topside equipment 7 may be included to further control operations, provide greater analysis capabilities as well as data logging and the like. A communications channel (not shown) may provide for communications to the topside equipment 7, and may operate via pulsed mud, wired pipe, and other technologies as are known in the art.

Generally, data from the MWD apparatus provide users with enhanced capabilities. For example, data made available from MWD evolutions may be useful as inputs to geosteering of the drill string 11 and the like.

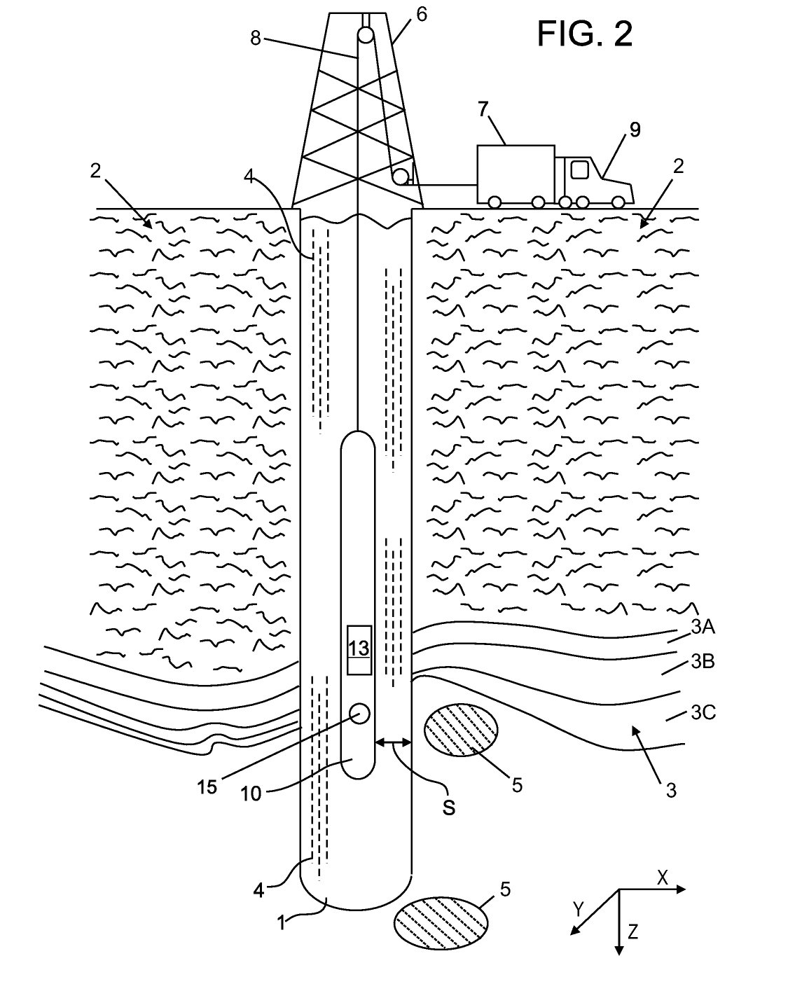

Reference may now be had to FIG. 2 where the well logging instrument 10 (also referred to as a “tool”) used for wireline logging is shown disposed in the wellbore 1. As a matter of convention, a depth of the wellbore 1 is described along a Z-axis, while a cross-section is provided on a plane described by an X-axis and a Y-axis. Prior to well logging with the logging instrument 10, the wellbore 1 is drilled into the Earth 2 using a drilling rig, such as one shown in FIG. 1.

As in the embodiment of FIG. 1, the wellbore 1 in the embodiment of FIG. 2 is filled, at least to some extent, with the drilling fluid 4.

The logging instrument 10 is lowered into the wellbore 1 using a wireline 8 deployed by a derrick 6 or similar equipment. Generally, the wireline 8 includes suspension apparatus, such as a load bearing cable, as well as other apparatus. The other apparatus may include a power supply, a communications link (such as wired or optical) and other such equipment. Generally, the wireline 8 is conveyed from a service truck 9 or other similar apparatus (such as a service station, a base station, etc, . . . ). Often, the wireline 8 is coupled to topside equipment 7. The topside equipment 7 may provide power to the logging instrument 10, as well as provide computing and processing capabilities for at least one of control of operations and analysis of data.

Generally, the logging instrument 10 includes apparatus for performing measurements “downhole” or in the wellbore 1. Such apparatus include, for example, a variety of sensors 15. Exemplary sensors 15 may include radiation detectors. The sensors 15 may communicate with downhole electronics 13. The measurements and other sequences as may be performed using the logging instrument 10 are generally performed to ascertain and qualify a presence of hydrocarbons 5.

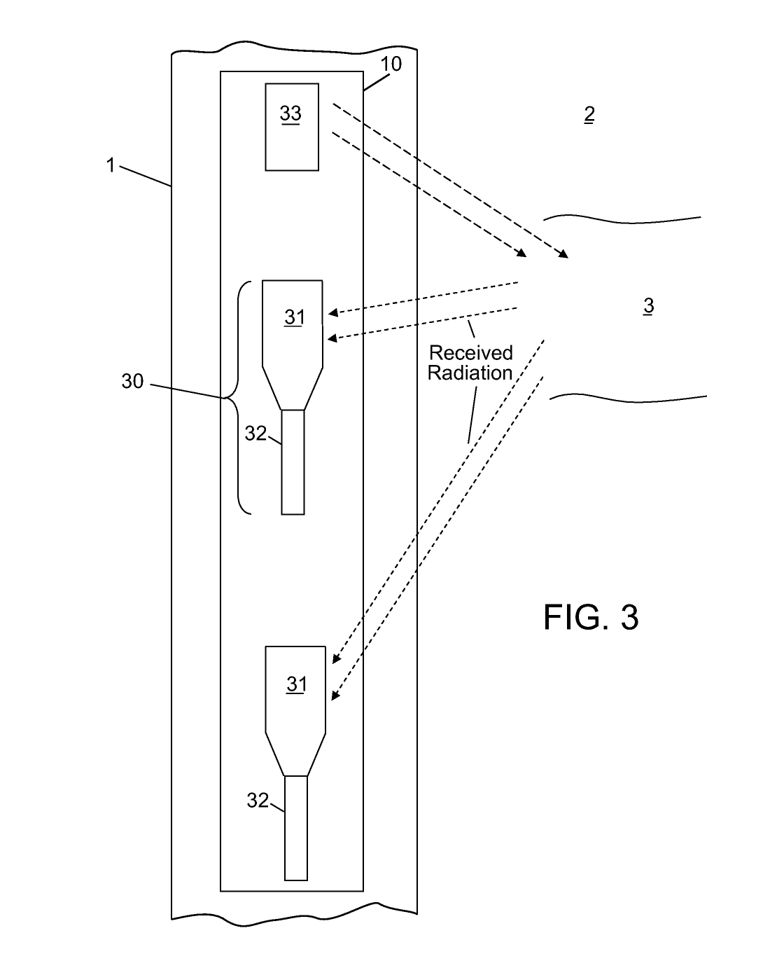

Reference may now be had to FIG. 3. FIG. 3 depicts aspects of the logging tool 10. The logging tool 10 includes at least one radiation detector 30. The radiation detector 30 includes a scintillation crystal 31 that is optically coupled to a photodetector 32. In general, the photodetector 32 is coupled to the downhole electronics 13 (not shown). The radiation detector 30 can be configured to measure natural radiation such as natural gamma ray radiation or radiation resulting from irradiation of a subsurface material. To irradiate the subsurface material, the logging tool 10 can include a radiation source 33. The radiation source 33 can be configured to emit gamma rays and/or neutrons. When used with the radiation source 33, the logging tool 10 can include a plurality of radiation detectors 30 where each radiation detector 30 has a different spacing from the radiation source 33.

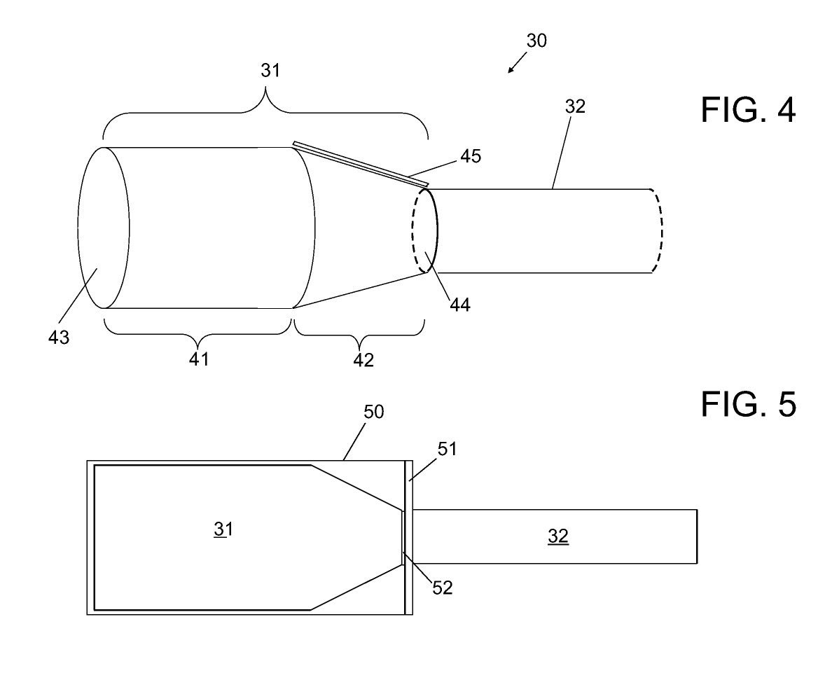

Reference may now be had to FIG. 4. FIG. 4 depicts aspects of the radiation detector 30. The scintillation crystal 31 in the embodiment of FIG. 4 includes a first portion 41 and a second portion 42. The first portion 41 has a first cross-sectional area 43. The photodetector 32 in the embodiment of FIG. 4 includes a second cross-sectional area 44 that is configured to be optically coupled to the scintillation crystal 31. In the embodiment of FIG. 4, the scintillation crystal 31 tapers from the first cross-sectional area 43 to the second cross-sectional area 44 where the crystal 31 is optically coupled to the photodetector 32. As shown in FIG. 4, the crystal 31 tapers linearly over the second portion 42. In another embodiment, the crystal 31 can taper with a curvature over the second portion 42. The curvature can be designed to reflect or guide photons from the crystal 31 into the photodetector 32. In some embodiments, a material reflective to photons (i.e., a reflector 45) can surround the scintillation crystal 31 at the second portion 42. The reflector 45 is configured to reflect those photons, which may otherwise exit the crystal 31 without entering the photodetector 32, into the photodetector 32.

In some cases, the scintillation crystal 31 that is hygroscopic may have radiation detection characteristics that make it desirable to use. For theses cases, the scintillation crystal 31 may be disposed in a hermetically sealed container 50 as shown in FIG. 5. The hermetically sealed container 50 is substantially void of air and water vapor to prevent deterioration of the scintillation crystal 31 that is hygroscopic. A wall of the container 50 is generally very thin to prevent the wall from absorbing or blocking radiation that would otherwise travel through the wall and into the container 50. In one embodiment, a wall of the container 50 is metallic having a thickness of about ten one-thousandths of an inch.

Still referring to FIG. 5, the container 50 includes a window 51 through which the generated photons exit the crystal 31 and the container 50 and enter the photodetector 32. In one non-limiting embodiment, the window 51 is transparent sapphire. In one embodiment, the crystal 31 is optically coupled to the window 51 with an optical coupling agent 52 such as an oil or a glue.

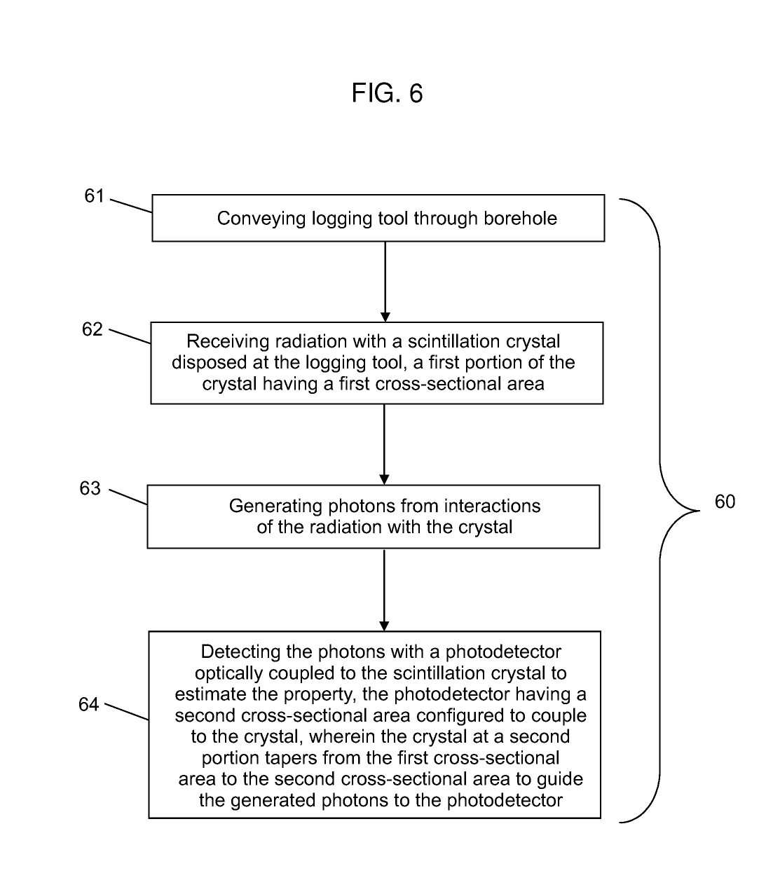

FIG. 6 presents one example of a method 60 for estimating a property in the borehole 1 penetrating the earth 2. The method 60 calls for (step 61) conveying the logging tool 10 through the borehole 1. Further, the method 60 calls for (step 62) receiving radiation with the scintillation crystal 31 disposed at the logging tool 10 where the crystal 31 has the first cross-sectional area 43 at the first portion 41. Further, the method 60 calls for (step 63) generating photons from interactions of the radiation with the crystal 31. Further, the method 60 calls for (step 64) detecting the photons with the photodetector 32 optically coupled to the scintillation crystal 31 to estimate the property, the photodetector 32 having the second cross-sectional area 44 configured to couple to the crystal 31 wherein the crystal 31 at the second portion 42 tapers from the first cross-sectional area 43 to the second cross-sectional area 44 to guide the generated photons to the photodetector 32.

The term “carrier” as used herein means any device, device component, combination of devices, media and/or member that may be used to convey, house, support or otherwise facilitate the use of another device, device component, combination of devices, media and/or member. The logging tool 10 is one non-limiting example of a carrier. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

In support of the teachings herein, various analysis components may be used, including a digital and/or an analog system. For example, the downhole electronics 13 or the topside equipment 7 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, shielding, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating a property in a borehole penetrating the earth, the apparatus comprising:
a carrier configured for being conveyed through the borehole;
a scintillation crystal disposed at the carrier, a first portion of the crystal having a first cross-sectional area; and
a photodetector optically coupled to the scintillation crystal and configured to detect photons generated in the crystal by interactions with radiation to estimate the property, the photodetector having a second cross-sectional area configured to couple to the crystal;
wherein the crystal at a second portion tapers from the first cross-sectional area to the second cross-sectional area to guide the generated photons to the photodetector.

2. The apparatus of claim 1, further comprising a reflective surface surrounding the second portion of the crystal.

3. The apparatus of claim 1, wherein the photodetector comprises a photomultiplier tube.

4. The apparatus of claim 1, wherein the photodetector comprises a photodiode.

5. The apparatus of claim 1, wherein the photodetector comprises a plurality of photodiodes.

6. The apparatus of claim 1, wherein the second portion of the crystal tapers linearly from the first cross-sectional area to the second cross-sectional area.

7. The apparatus of claim 1, wherein the second portion of the crystal tapers with a curvature from the first cross-sectional area to the second cross-sectional area.

8. The apparatus of claim 7, wherein the curvature is configured to direct photons from first cross-sectional area to the second cross-sectional area.

9. The apparatus of claim 1, wherein the scintillation crystal is hygroscopic.

10. The apparatus of claim 9, wherein the crystal is disposed in a hermetically sealed container configured to be substantially transparent to radiation.

11. The apparatus of claim 10, wherein the container is substantially evacuated of air.

12. The apparatus of claim 10, wherein the container comprises a window coupled to the photodetector, the window being substantially transparent to photons.

13. The apparatus of claim 12, wherein the window comprises sapphire.

14. The apparatus of claim 12, wherein the second cross-sectional area of the crystal is coupled to the window using an optical coupling agent.

15. The apparatus of claim 14, wherein the agent is at least one selection from a group consisting of an oil and a glue.

16. The apparatus of claim 1, further comprising a processor coupled to the photodetector and configured to measure counts of photons detected by the photodetector to estimate the property.

17. The apparatus of claim 1, wherein the property is at least one of porosity, density, composition, and a boundary between layers.

18. The apparatus of claim 1, wherein the radiation comprises gamma rays.

19. The apparatus of claim 18, wherein the scintillation crystal comprises a selection from a group consisting of sodium iodide, bismuth germinate, and a lanthanum halide.

20. The apparatus of claim 1, wherein the radiation comprises neutrons.

21. The apparatus of claim 20, wherein the scintillation crystal comprises a selection from a group consisting of lithium-six and boron-ten.

22. The apparatus of claim 1, further comprising a radiation source disposed at the carrier and configured to irradiate a material wherein radiation from the material is detected and used to estimate the property.

23. The apparatus of claim 1, wherein the carrier is conveyed by a selection from a group consisting of a wireline, a slickline, coiled tubing, and a drill string.

24. A method for estimating a property in a borehole penetrating the earth, the method comprising:
conveying a carrier through the borehole;
receiving radiation with a scintillation crystal disposed at the carrier, a first portion of the crystal having a first cross-sectional area;
generating photons from interactions of the radiation with the crystal; and
detecting the photons with a photodetector optically coupled to the scintillation crystal to estimate the property, the photodetector having a second cross-sectional area configured to couple to the crystal;
wherein the crystal at a second portion tapers from the first cross-sectional area to the second cross-sectional area to guide the generated photons to the photodetector.

25. The method of claim 24, further comprising irradiating a material using a radiation source disposed at the carrier wherein radiation resulting from the irradiating is received from the material.
